(19) United States
(12) Patent Application Publication
(10) Pub. No.: US 2009/0286322 A1
(43) Pub. Date: Nov. 19, 2009

(54) METHOD AND APPARATUS FOR DETECTING HARMFUL SUBSTANCES IN A FLUID

(76) Inventor: Donna Dancer, Vernon, AZ (US)

Correspondence Address: JAY M. SCHLOFF, 6960 Orchard Lake Road, Suite 315, West Bloomfield, MI, 48322, US

(21) Appl. No.: 12/121,872

(22) Filed: May 16, 2008

(51) Int. Cl. G01N 21/78

(52) U.S. Cl. 436/20; 422/57; 436/164; 436/98; 436/131

(57) ABSTRACT

Disclosed is a testing apparatus for detecting the presence of harmful substances in a fluid. The testing apparatus includes a base member and a flap member removably attached to the base member. Further, the testing apparatus includes at least one testing stick enclosed within the base member. The at least one testing stick includes an elongated member and a chemical reagent disposed on the elongated member. The chemical reagent is capable of reacting with the harmful substances. Such a reaction of the chemical agent with the harmful substances results in a change in a color of the chemical reagent indicating the presence of the harmful substances in the fluid. Further disclosed is a method for detecting the presence of the harmful substances in the fluid using the testing apparatus.

### FIELD OF THE INVENTION

The present invention relates generally to a method and an apparatus for detecting the presence of harmful substances in a fluid, such as a beverage.

### BACKGROUND OF THE INVENTION

With an increase in the trend of dating among adolescents and grown-up population, cases of sexual assaults while dating have also witnessed an increase. Generally, perpetrators committing such sexual assaults use toxic or harmful substances to temporarily retard the physical and psychological activity of their victims. Suitable examples of such toxic substances include chemical drugs such as flunitrazepam, available under the trade name, ‘Rohypnol,’ and gamma hydroxyl butyrate (GHB). These chemical drugs usually have applications in medical treatments, and consequently, are available at common medical stores. For example, Rohypnol is a white tablet that is used in medicinal science for treating severe sleep disorder. Similarly, GHB, also known as liquid ecstasy, is a naturally occurring metabolite, and is used in medicinal science for treating neurological disorders, enhancing muscle strength and increasing rate of release of growth hormones.

However, an inappropriate dose of the chemical drugs is known to prevent generation of sensory impulses or responses by the victims or any human body after consumption thereof. For example, Rohypnol has no taste or odor, and on consumption without any medical supervision or prescription, the chemical drug may cause harmful effects such as drowsiness, impaired motor skills, impaired judgment, reduced inhibition, dizziness and confusion. Similarly, GHB has the capacity to produce intoxication and amnesia. Further, a combination of the two chemical drugs in a beverage may serve as a partial anaesthetic, thereby causing partial or full amnesia. Most often than not, the chemical drugs may be mixed with alcoholic beverages to affect the victims to a greater extent.

Administration of such chemical drugs in beverages, therefore, results in producing the aforementioned harmful effects on a victim who may gradually be targeted for a sexual assault, or robbery, or any other such incidence. Further, the harmful effects of the chemical drugs may start within 15 minutes to 20 minutes, post-consumption, thereby providing a short time for the victim to raise a safety alarm. The aforementioned effects become much more severe when the chemical drugs are administered in heavy doses to the victim. Further, administration of a heavy dose of the chemical drugs may result in a permanent psychological damage to the victim and in some cases an overdose may result in an instant death of the victim.

Accordingly, various testing apparatuses and methods have been employed for detecting the toxic substances, such as the afore-mentioned chemical drugs, in a fluid, such as a beverage. Such conventional testing apparatuses employ test strips that may work on a principle of a visual indication when dipped in the fluid having the toxic substances. However, use of such conventional test strips has not proven to be very reliable. Alternatively, some of the conventional testing apparatuses include a hollow casing, a plurality of beads and a test strip. The hollow casing includes an interior volume and an interior surface. The plurality of beads is disposed within the interior volume of the hollow casing. The test strip is disposed on the interior surface of the casing. For detecting the presence of the toxic substances in the fluid, the testing apparatus is dipped into the fluid. The beads provide a visual indication to show the presence of the toxic substances in the fluid. Another such complex conventional testing apparatus exists in the form of an analyte testing cassette having different units of analytic devices required for detecting the toxic substances. However, all such conventional testing apparatuses involve a complex configuration. Further, these conventional testing apparatuses are bulky, expensive, and not easily portable. Furthermore, most of such conventional testing apparatuses are difficult-to-operate.

Accordingly, there is a need to develop a testing apparatus for an easy and quick detection of toxic or harmful substances that may be present in a fluid prepared for consumption by a user. Further, the testing apparatus should be compact and portable. Furthermore, there is a need for developing a method for detecting the presence of harmful substances in a fluid in an easy and a reliable manner.

### SUMMARY OF THE INVENTION

In view of the foregoing disadvantages inherent in the prior art, the general purpose of the present invention is to provide a testing apparatus and a method of use thereof for detecting the presence of harmful substances in a fluid, such as a beverage, which includes all the advantages of the prior art, and overcomes the drawbacks inherent therein.

Accordingly, an object of the present invention is to provide an easy, a quick and a reliable means for detecting the presence of harmful substances in a fluid.

Another object of the present invention is to provide a method for detecting the presence of harmful substances in a fluid.

In light of the above objects, in one aspect, the present invention discloses a testing apparatus for detecting the presence of a harmful substance in a fluid. The testing apparatus includes a base member having a first folded portion and a second folded portion, and a flap member removably attached to the first folded portion of the base member. Further, the testing apparatus includes at least one testing stick enclosed within the base member. The at least one testing stick includes an elongated member and a chemical reagent disposed on the elongated member. The chemical reagent is capable of reacting with the harmful substance. The reaction of the chemical reagent with the harmful substance results in a change in a color of the chemical reagent indicating the presence of the harmful substance in the fluid.

Further, in another aspect, the present invention discloses a testing stick for detecting the presence of a harmful substance in a fluid. The testing stick includes an elongated member. Further, the testing stick includes a chemical reagent disposed on the elongated member. The chemical reagent is capable of reacting with the harmful substance. The reaction of the chemical reagent with the harmful substance results in a change in a color of the chemical reagent indicating the presence of the harmful substance in the fluid.

Furthermore, in yet another aspect, the present invention discloses a method for detecting the presence of a harmful substance in a fluid. The method includes providing the fluid and inserting at least one testing stick in the fluid. The at least one testing stick includes an elongated member and a chemical reagent disposed on the elongated member. The chemical reagent is capable of reacting with the harmful substance. Further, the method includes observing a change in a color of the chemical reagent after inserting the at least one testing stick in the fluid. The change in the color indicates the presence of the harmful substance in the fluid.

This together with other embodiments of the present invention, along with the various features of novelty that characterize the invention, are pointed out with particularity in the claims annexed hereto and form a part of this disclosure. For a better understanding of the present invention, its operating advantages, and the specific objects attained by its uses, reference should be made to the accompanying drawing and the descriptive matter in which there are illustrated exemplary embodiments of the present invention.

### BRIEF DESCRIPTION OF THE DRAWING

The advantages and features of the present invention will become better understood with reference to the following detailed description and claims taken in conjunction with the accompanying drawing, in which:

FIG. 1 depicts a perspective view of a testing apparatus for detecting the presence of harmful substances in a beverage, according to an exemplary embodiment of the present invention.

### DETAILED DESCRIPTION OF THE INVENTION

The exemplary embodiments described herein detail for illustrative purposes are subject to many variations in structure and design. It should be emphasized, however, that the present invention is not limited to a particular apparatus and a method for detecting harmful substances in a fluid, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The present invention provides a testing apparatus for detecting the presence of one or more harmful substances (hereinafter referred to as harmful substances) in a fluid. The term ‘harmful substances,’ as used herein, refers to toxic substances or chemical drugs that are capable of temporarily retarding physical and psychological activity of a human being. Suitable examples of such harmful substances include, but are not limited to, flunitrazepam (available under the trade name, ‘Rohypnol’), gamma hydroxyl butyrate (GHB), and a combination thereof. Further, the term ‘fluid,’ as used herein, refers to liquid substances that are suitable for consumption by humans. Suitable examples of such liquid substances may include, but are not limited to, alcoholic beverages and non-alcoholic beverages. Specific examples of the liquid substances may include, but are not limited to, coffee, tea, juices, soft drinks, and hard drinks. For the purpose of this description, the term ‘fluid’ may hereinafter interchangeably be referred to as a ‘beverage’.

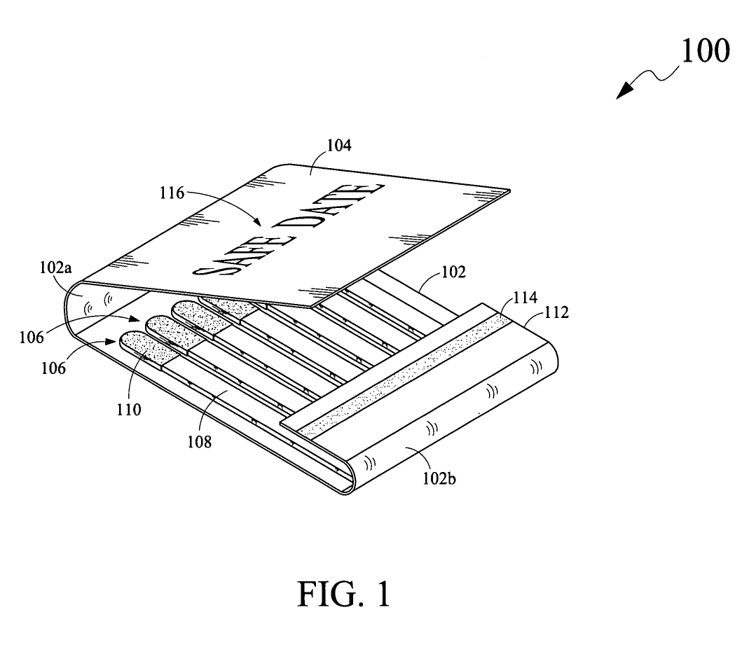

The testing apparatus of the present invention is explained in detail in conjunction with FIG. 1.

FIG. 1 depicts a perspective view of a testing apparatus 100 for detecting the presence of harmful substances in a beverage, according to an exemplary embodiment of the present invention. As shown in FIG. 1, the testing apparatus 100 includes a base member 102 having a first folded portion 102a and a second folded portion 102b. It should be understood that the base member 102 may be made of a structurally strong, lightweight, attractive, and stackable material. More specifically, the base member 102 may be made of a material, such as a cardboard material, a plastic material, and a paper material. For the purpose of this description, the base member 102 is a rectangular cardboard of a dimension that is sufficient enough to hold contents of the testing apparatus 100. The contents of the testing apparatus 100 are explained in detail in the following description of the present invention. It should be well understood that the base member 102, as used herein, may be manufactured in other shapes and sizes.

Further, the testing apparatus 100 includes a flap member 104 removably attached to the base member 102. More specifically, the flap member 104 is removably attached to the base member 102 through the first folded portion 102a of the base member 102. The flap member 104 provides a covering that protects the contents of the testing apparatus 100. For the purpose of this description, the flap member 104 is a sheet of paper having a rectangular shape and a dimension sufficient enough to cover the contents of the testing apparatus 100. However, it should be understood that the flap member 104 may be manufactured in other shapes and sizes as well. It should also be understood that the flap member 104 may be an inherent element of the testing apparatus 100.

Further, the testing apparatus 100 includes at least one testing stick, hereinafter referred to as testing sticks 106, enclosed within the base member 102. The testing sticks 106 are referred to as the contents of the testing apparatus 100. For the purpose of this description, the testing sticks 106 are attached to the base member 102. More specifically, the testing sticks 106 are attached to the base member 102 with the help of an adhesive. Alternatively, it should be understood that the base member 102 may include a plurality of grooves (not shown) for enclosing the testing sticks 106 within the base member 102.

Each of the testing sticks 106 include an elongated member 108 and a chemical reagent 110 disposed on the elongated member 108. More specifically, the chemical reagent 110 is disposed on a portion of the elongated member 108. Without departing from the scope of the present invention, it should be understood that the chemical reagent 110 may be disposed on the elongated member 108 to completely cover the elongated member 108. Moreover, any known method may be used for disposing the chemical reagent 110 onto the elongated member 108. Suitable examples of such a known method may include, but are not limited to, coating and impregnation.

For the purpose of this description, the elongated member 108 may be an element that has notably a much larger length than width to provide an easy means for dipping the testing sticks 106 into the beverage such that the chemical reagent 110 is in direct contact with the beverage. Suitable examples of the elongated member 108 include, but are not limited to a stick, a strip, a pipe and the like.

The chemical reagent 110 is capable of reacting with the harmful substances, as disclosed above, that may be present in the beverage. Moreover, the reaction of the chemical reagent 110 with the harmful substances results in a change in a color of the chemical reagent 110 indicating the presence of the harmful substances in the beverage. Therefore, by inserting or dipping the testing sticks 106 in a beverage to be tested, and thereafter by observing any change in the color of the chemical reagent 110, one may detect the presence of harmful substances in the beverage. It should be understood that the change in the color of the chemical reagent 110 provides a visual indication for the presence of the harmful substances in the beverage. Further, it should be also understood that the chemical reagent 110 may not be toxic to render the beverage non-drinkable for use. Furthermore, the chemical reagent 110, as used herein, may be any chemical reagent known in the art that is capable of reacting with the harmful substances present in a beverage.

Without departing from the scope of the present invention, it should be apparent to a person skilled in the art that after the reaction of the chemical reagent 110 with the harmful substances, a color change may be reflected at portions of the testing sticks 106 where the chemical reagent 110 may be disposed on. Therefore, it should be understood that using a terminology to recite that a change in the color of the testing sticks 106, having the chemical reagent 110, is indicative of the presence of the harmful substances in the fluid, does not limit the scope of the present invention.

Furthermore, the testing apparatus 100 may optionally include a support member, such as a support member 112. The support member 112 helps in holding the testing sticks 106 thereby preventing the testing sticks 106 to drop-off from the testing apparatus 100. As shown in FIG. 1, the support member 112 is attached to the base member 102 through the second folded portion 102b of the base member 102. The support member 112 may include an adhesive layer 114. More specifically, the flap member 104 may be fixed over the support member 112 with the help of the adhesive layer 114 so as to enclose the testing sticks 106 inside the testing apparatus 100 thereby completely covering the contents of the testing apparatus 100. It should be understood that the flap member 104 is temporarily fixed on the support member 112 such that prior to using the testing sticks 106, the flap member 104 may be easily lifted-up for withdrawing the testing sticks 106 from within the testing apparatus 100. It should also be understood that the testing apparatus 100 may employ an alternate means for temporarily fixing the flap member 104 over the support member 112.

Moreover, as shown in FIG. 1, the testing apparatus 100 may include one or more labels, such as a label 116, on an outer surface (not shown) thereof. More specifically, the label 116 may represent a trade name imprinted or fixed on an outer surface of the flap member 104. For the purpose of this description, the trade name is depicted by a label representing, “SAFE DATE,” which is imprinted or fixed on the outer surface of the flap member 104 during manufacturing of the testing apparatus 100. It should be understood that the one or more labels may be imprinted or fixed on one or more surfaces of any element, such as the base member 102, the flap member 104, or the support member 112, of the testing apparatus 100. It should also be understood that the one or more labels may be designed in standard or custom sizes and shapes, colors, and materials, depending on a manufacturer's preferences, and accordingly may not be considered as limiting to the scope of the present invention.

In addition, the testing apparatus 100 may include a set of instructions (not shown in the FIGURE). The set of instructions may illustrate a technique for using the testing apparatus 100 for detecting the presence of the harmful substances in the beverage. More specifically, the set of instructions may be imprinted on an inner surface of the testing apparatus 100 during manufacturing thereof. Further, such a set of instructions may include a color scheme depicting an initial color of the chemical reagent 110 before using the testing sticks 106 and a final color of the chemical reagent 110 so-obtained after using the testing sticks 106.

From FIG. 1, it should be understood that the testing apparatus 100 serves as a detection system that is uniquely shaped as a match book from which a user may withdraw the testing sticks 106 to test ingredients of a beverage. More specifically, the testing sticks 106 serve as chemically formulated dip sticks enclosed within the matchbook.

In another aspect, the present invention provides a method for detecting the presence of the harmful substances in a beverage using the testing apparatus, such as the testing apparatus 100 of FIG. 1. The testing apparatus includes at least one testing stick (hereinafter referred to as testing sticks), such as testing sticks 106. The testing sticks include an elongated member, such as the elongated member 108, and a chemical reagent, such as the chemical reagent 110, disposed on the elongated member. The chemical reagent is capable of reacting with the harmful substances that may be present in the beverage. Moreover, the reaction of the chemical reagent with the harmful substances results in a change in a color of the chemical reagent and such a change in the color indicates the presence of the harmful substances in the beverage. Accordingly, the method for detecting the presence of the harmful substances includes providing the beverage and inserting the testing sticks in the beverage. Further, the method includes observing a change in the color of the chemical reagent disposed on the testing sticks after inserting the testing sticks in the fluid. The change in the color of the chemical reagent indicates the presence of the harmful substances in the beverage. For the purpose of this description, such an indication detecting the presence of the harmful substances in the beverage may be referred as a ‘positive test’. Moreover, no change in the color of the chemical reagent after inserting the testing sticks in the beverage indicates an absence of the harmful substances in the beverage and such an indication may be referred as a ‘negative test’. Accordingly, a positive test of the beverage may indicate to a user that the beverage is adulterated with the harmful substances and is unsafe to consume, whereas a negative test may indicate to the user that the beverage is not adulterated with the harmful substances and is safe to consume.

Based on the forgoing, the present invention provides a testing apparatus for detecting the presence of harmful substances, such as flunitrazepam and GHB, in a beverage. The testing apparatus includes testing sticks having a chemical reagent that is capable of reacting with the harmful substances that may be present in the beverage. The reaction of the chemical reagent with the harmful substances results in a change in a color of the chemical reagent thereby providing a visual indication for the presence of the harmful substances in the beverage. The said property of the testing apparatus therefore enables a user to ensure safety of the beverage prior to drinking. Therefore, the testing apparatus serves as a detection system that is designed as a match book from which a user may withdraw testing sticks to test ingredients of his or her drink. A change in color of the chemical reagent may alarm the user about the presence of the harmful substances in his or her drink. Moreover, the testing apparatus of the present invention is compact and convenient-to-carry to places such as restaurants and bars, and such similar places that are fixed by people to meet for dating purposes. Further, the testing apparatus is easy and quick-to-use as it does not require following any complex set of instructions prior to use. The present invention also provides a method for detecting the presence of the harmful substances in the beverage, using the testing apparatus, in a reliable, quick and an easy manner. Therefore, the method and the testing apparatus serve as effective alarming tools for a user for his or her personal safety and security while drinking a fluid in the company of others.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, and thereby enable others skilled in the art to best utilize the invention and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present invention.

What is claimed is:

1. A testing apparatus for detecting the presence of a harmful substance in a fluid, the testing apparatus comprising:
a base member having a first folded portion and a second folded portion;
a flap member removably attached to the first folded portion of the base member; and
at least one testing stick enclosed within the base member, the at least one testing stick comprising,
an elongated member, and
a chemical reagent disposed on the elongated member, the chemical reagent capable of reacting with the harmful substance, wherein the reaction of the chemical reagent with the harmful substance results in a change in a color of the chemical reagent indicating the presence of the harmful substance in the fluid.

2. The testing apparatus of claim 1 further comprising a support member attached to the second folded portion of the base member.

3. The testing apparatus of claim 1, wherein the harmful substance is at least one of flunitrazepam and gamma hydroxyl butyrate.

4. The testing apparatus of claim 1, wherein the fluid is a beverage.

5. A testing stick for detecting the presence of a harmful substance in a fluid, the testing stick comprising:
an elongated member; and
a chemical reagent disposed on the elongated member, the chemical reagent capable of reacting with the harmful substance, wherein the reaction of the chemical reagent with the harmful substance results in a change in a color of the chemical reagent indicating the presence of the harmful substance in the fluid.

6. The testing stick of claim 5, wherein the harmful substance is at least one of flunitrazepam and gamma hydroxyl butyrate.

7. The testing stick of claim 5, wherein the fluid is a beverage.

8. A method for detecting the presence of a harmful substance in a fluid, the method comprising:
providing the fluid;
inserting at least one testing stick in the fluid, the testing stick comprising,
an elongated member, and
a chemical reagent disposed on the elongated member, the chemical reagent capable of reacting with the harmful substance; and
observing a change in a color of the chemical reagent after inserting the at least one testing stick in the fluid, wherein the change in the color indicates the presence of the harmful substance in the fluid.

9. The method of claim 8, wherein the harmful substance is at least one of flunitrazepam and gamma hydroxyl butyrate.

10. The method of claim 8, wherein the fluid is a beverage.
